(19) United States
(12) Patent Application Publication
(10) Pub. No.: US 2026/0346194 A1
(43) Pub. Date: Nov. 5, 2026

(54) HIGH-EFFICIENCY PLASMA REMEDIATION REACTOR REACTOR FOR HAZARDOUS GAS DISSOCIATION WITH ENHANCED NEUTRALIZATION CAPABILITY

(71) Applicants: Peter Renteln, Kenvil, NJ (US); Bruce Freeman, Lincoln, CA (US)

(72) Inventors: Peter Renteln, Kenvil, NJ (US); Bruce Freeman, Lincoln, CA (US)

(73) Assignee: Icarus Thermal Solutions, Kenvil, NJ (US)

(21) Appl. No.: 19/675,118

(22) Filed: May 12, 2026

(51) Int. Cl. B01D 53/32; B01D 53/04; B01D 53/75; B01D 53/76; H05H 1/46

(52) U.S. Cl. CPC B01D 53/32; B01D 53/04; B01D 53/75; B01D 53/76; H05H 1/4637; B01D 2251/102; B01D 2251/11; B01D 2253/102; B01D 2253/112; B01D 2258/0216; B01D 2259/806; B01D 2259/818

(57) ABSTRACT

The present invention provides a high-efficiency gas-phase reactor for dissociating hazardous molecules, particularly semiconductor process exhaust gases. Microwave power is delivered to a conductive emitter positioned within the reaction chamber to generate plasma and/or pyrolytic dissociation. An annular region surrounding the reaction chamber receives a motive fluid that simultaneously cools the reactor and, together with a downstream constriction, creates a Venturi-effect low-pressure zone for dry gas motivation. Various reactor embodiments include multi-pass flow geometries, double-helix independently powered emitters, hybrid plasma-pyrolytic stages utilizing susceptors or absorptive media, and integrated eductor architectures. The reactor achieves high dissociation efficiency with significantly reduced molecular fragments, minimal carrier gas consumption, lower cost of ownership, smaller facility footprint, and improved maintainability compared to conventional remediation systems.

### CROSS-REFERENCE TO RELATED APPLICATIONS

This application is a continuation-in-part of U.S. patent application Ser. No. 19/266,644, filed on Jul. 11, 2025, the entire disclosure of which is hereby incorporated by reference.

### BACKGROUND OF THE INVENTION

The Background of the Invention from the parent application (original paragraph numbers 0002 to 0003) is incorporated herein by reference.

### SUMMARY OF THE INVENTION

The Summary of the Invention from the parent application (original paragraph numbers 0004 to 0005) is incorporated herein by reference.

### BRIEF DESCRIPTION OF THE DRAWINGS

The Brief Description of the Drawings from the parent application (original paragraph numbers 0006 to 0010) is incorporated herein by reference.

### DETAILED DESCRIPTION OF THE INVENTION

The Detailed Description of the Invention, including the description of FIGS. 1-4, from the parent application (original paragraph numbers 0011 to 0082) is incorporated herein by reference in its entirety.

### New Matter Added in the Continuation-In-Part Application

### SUMMARY OF THE INVENTION

In a preferred embodiment, the present invention relates to a gas-phase reactor for dissociating gas-phase molecules, particularly hazardous exhaust gases generated during semiconductor etch and deposition processes. The reactor achieves the same overall purpose as the systems disclosed in the parent application but introduces microwave energy into the reaction chamber in a new and improved manner.

Microwave power is delivered from a microwave source via a transmission system to a conductive emitter positioned to re-radiate microwave energy into the reaction chamber. The conductive emitter may comprise a straight rod with optional geometric features, a coil, a double-helix configuration with optionally independently powered interleaved helices, or combinations thereof, thereby enabling efficient plasma and/or pyrolytic dissociation of the process gases.

In further embodiments, the reactor includes an annular region surrounding at least a portion of the reaction chamber. This annular region receives a motive fluid and, together with a downstream neck-down constriction, forms an eductor that generates a low-pressure zone. The low-pressure zone motivates the process gas through the dissociation media and any downstream remediation or adsorbent stages. The annular architecture simultaneously provides cooling to the reaction chamber, serves as a carrier gas, acts as an insulator, keeping the stainless steel reactor housing cool, and may optionally introduce a reactive gas.

The invention further provides removable adsorbent and activated media beds that facilitate rapid replacement while preserving system integrity. The reactor encompasses numerous variations and combinations of these features, including multi-pass flow geometries, hybrid plasma-pyrolytic sections utilizing susceptors or absorptive media, and various heat-exchange structures within the annular region. The resulting system achieves high dissociation efficiency with significantly reduced cost of ownership, improved maintainability, smaller facility footprint, and lower consumables usage compared to conventional remediation systems.

### BRIEF DESCRIPTION OF THE DRAWINGS

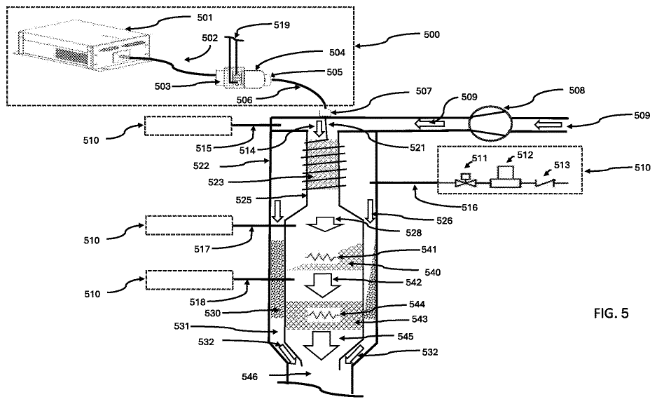

FIG. 5 illustrates a detailed schematic of one embodiment of the high-efficiency plasma remediation reactor according to the present continuation-in-part application, showing the magnetron power assembly, coaxial microwave delivery system, reactor chamber with microwave emitter and porous media, downstream adsorbent and activated media beds, annular gas motivation and cooling architecture, low-pressure eductor mixing zone,

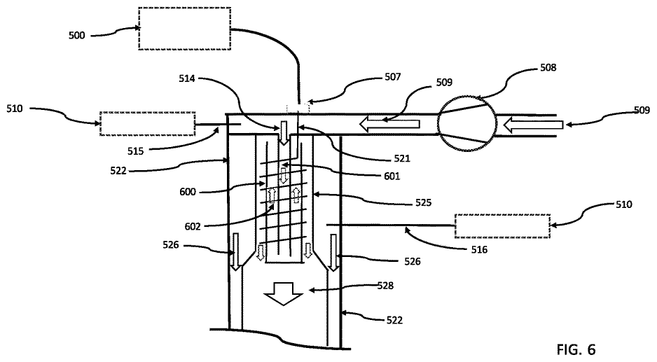

FIG. 6 illustrates a multi-pass embodiment of the high-efficiency plasma remediation reactor according to the present continuation-in-part application, featuring a multi-pass high-temperature microwave-transparent reactor housing that forces the exhaust gas to traverse the plasma and microwave field multiple times for increased residence time, along with the coaxial magnetron delivery system, and annular gas injection architecture.

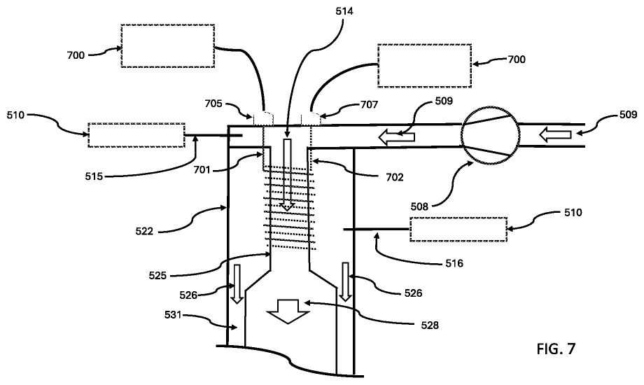

FIG. 7 illustrates an alternative embodiment of the plasma remediation reactor in which microwave power is generated by a solid-state microwave source, such as a Gallium Nitride (GaN) amplifier. FIG. 7 further illustrates double-helix independently powered microwave emitter coils embodiment of the high-efficiency plasma remediation reactor according to the present continuation-in-part application, featuring two interleaved helical emitters and annular gas motivation architecture.

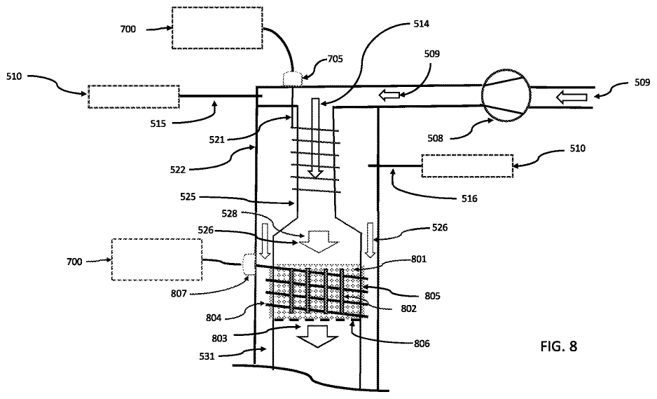

FIG. 8 illustrates a hybrid plasma/pyrolytic embodiment of the plasma remediation reactor utilizing a solid-state microwave generator, such as a Gallium Nitride (GaN) amplifier, in place of the magnetron-based system shown in FIG. 5. This embodiment features an initial plasma dissociation stage followed by a high-temperature pyrolytic stage containing embedded microwave-absorptive susceptors (such as SiC rods) within a gas-permeable media, along with the annular gas motivation and cooling architecture. (Adsorbent stages and eductor architecture not shown).

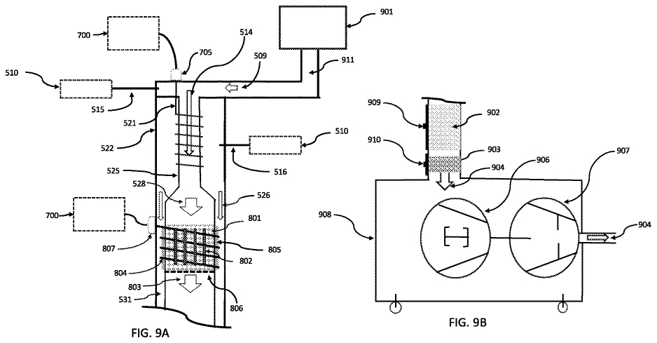

FIGS. 9A and 9B illustrate a low-maintenance, embodiment of the high-efficiency plasma remediation reactor system according to the present continuation-in-part application utilizing a solid-state microwave generator. FIG. 9A shows a detailed cross-sectional view of the reactor with hybrid plasma-pyrolytic stages substantially like FIG. 8 (eductor architecture not shown), while FIG. 9B provides a simplified system-level view showing integration with FIG. 9A with the adsorbent and activated media beds located in the foreline immediately upstream of the backing vacuum pump assembly.

### DETAILED DESCRIPTION OF THE INVENTION

In further embodiments, the present invention provides improved microwave delivery systems, multi-functional annular gas motivation and cooling architectures, and integrated eductor designs. Referring now to FIG. 5, a preferred embodiment of the plasma remediation reactor according to the present continuation-in-part application is shown in schematic form.

A Magnetron Power Assembly 500 comprises a Magnetron Power Supply 501 that delivers electrical power through a Magnetron Power Cable 502 to a Magnetron 503. The microwave output from the magnetron is coupled through a Coaxial Magnetron Launcher 504, such as the CMLD series offered by sTEAM MW Technologies or equivalent devices. The microwave energy then travels through an EIA Coaxial Connector 505, a Coaxial Cable 506, and a second EIA Coaxial Connector 507 into the reactor. The assembly also includes a Magnetron water cooling circuit 519 that circulates cooling water through the magnetron to remove excess heat. This cooling circuit may be recycled into facility infrastructure for heating purposes. This coaxial delivery system advantageously allows the relatively heavy and heat-generating magnetron to be physically separated from the reactor assembly, eliminating the need for bulky rectangular waveguides, reduces thermal coupling, and improves overall system flexibility and maintainability.

While the embodiments described above utilize a magnetron as the microwave source, the invention is not limited to this device. Microwave energy may alternatively be generated by other suitable means known in the art. In one preferred alternative embodiment, solid-state microwave generators, such as high-power Gallium Nitride (GaN) amplifiers or other semiconductor-based sources, may be employed. Solid-state sources offer advantages including precise frequency and power control, fast modulation capability, longer operational lifetime, and lower voltage requirements compared to traditional vacuum tube devices. Other alternative microwave generation technologies, such as klystrons or traveling wave tubes, may also be used in applications requiring very high-power levels. In all cases, the generated microwave energy is delivered to the microwave emitter within the reactor using appropriate transmission lines, coaxial cables, or waveguides to create the desired electromagnetic field for plasma and/or pyrolytic dissociation.

Although not shown in the figures, the microwave delivery system may optionally include additional components commonly used in microwave plasma systems, such as tuning stubs, impedance matching networks, circulators, isolators, directional couplers, dummy loads, or phase shifters. These components may be employed to optimize power transfer, minimize reflected power, protect the microwave source from reflected energy, and ensure stable plasma operation under varying gas loads and pressures. Such components are well-known to those skilled in the art of microwave engineering and may be integrated into the coaxial transmission line, magnetron launcher, or solid-state source output as needed. The present invention is intended to encompass embodiments both with and without such auxiliary microwave components.

Process exhaust gas is drawn from a Semiconductor Process Backing Vacuum Pump 508. The Un-Remediated Process Exhaust 509 consists of untreated hazardous gases exiting the semiconductor process tool. This Un-Remediated Process Exhaust 509 enters the reactor and may be mixed with reactive or carrier gases supplied by a Gas Injection Module Assembly 510. The Gas Injection Module Assembly comprises a Gas Isolation Valve 511, Gas Flow Control Valve 512, and One-Way Flow Check Valve 513. The resulting Mixed Fluid 514 is composed of the Un-Remediated Process Exhaust 509 and the gases delivered through the Pre-Remediation Mixing Reactive or Carrier Gas Injection Line 515 that feeds into the reactor.

Microwave power is delivered to a Microwave Emitter 521 positioned proximate to or surrounding a Microwave-Transparent Reactor Housing 525. Suitable materials for the Microwave-Transparent Reactor Housing 525 include quartz, fused silica, pyrolytic boron nitride PBN, hot-pressed boron nitride, or other low-loss dielectric ceramics capable of withstanding high-temperatures and plasma environments. The Microwave-Transparent Reactor Housing 525 contains a Gas Permeable Ceramic Media 523 such as sintered hBN, alumina beads, silicon carbide foam, or other engineered porous media and is enclosed within a Stainless-Steel Reactor Housing 522 and is supported by a ceramic screen (not shown).

The Gas Permeable Ceramic Media 523 located inside the Microwave-Transparent Reactor Housing 525 or surrounding the emitter if the emitter is a rod serves two critical purposes. First, the sharp edges, corners, and pore intersections within the porous structure locally enhance the microwave field strength, increasing ionization and electron density within the pores. This results in more effective plasma formation and dissociation. Second, the tortuous path through the porous media significantly slows the gas velocity, thereby increasing residence time in the high-intensity dissociation zone.

The chemical composition of the Gas Permeable Ceramic Media 523 can be selected to tailor the balance between plasma and pyrolytic dissociation. A material with low microwave absorptivity such as high-purity hexagonal boron nitride allows a greater proportion of the energy to remain in the plasma state. Conversely, a material with higher microwave absorptivity, such as Zirconia or Alumina will heat more readily, increasing the pyrolytic contribution and raising the temperature of the media itself. This ability to tune the plasma-to-pyrolysis ratio is a significant advantage of the present invention. Gas exiting the Gas Permeable Ceramic Media 523 is the dissociated gas 528. Post dissociation reactive or carrier gas injection line 517 such as oxygen or CDA then combines with dissociated gas 528 to oxidize atomic metals to make them easier to collect in calcium carbide absorptive bed 540.

Downstream of the dissociation zone, the Post-Dissociated Exhaust 528 flows into one or more adsorbent or capture media beds 540. In a preferred embodiment, the adsorbent media comprises calcium carbonate (CaCO₃) pellets or granules. Other suitable adsorbent or reactive media known in the art may alternatively or additionally be used, including calcium oxide, magnesium oxide, zeolites, activated alumina, metal hydroxides, metal-organic frameworks, or combinations thereof. The primary purpose of the adsorbent bed(s) is to rapidly neutralize and capture highly reactive dissociated elements and molecular fragments before they can recombine.

In a preferred embodiment, the Adsorptive Media 540 comprises calcium carbonate (CaCO₃) pellets or granules. The primary purpose of the calcium carbonate bed is to rapidly neutralize and capture the highly reactive dissociated elements and fragments before they can recombine into hazardous molecules. For example, fluorine atoms and radicals react with CaCO₃ to form stable calcium fluoride (CaF₂); sulfur species form calcium sulfide (CaS) or calcium sulfate (CaSO₄); tungsten and silicon fluorides are converted into stable salts; and other halogens such as bromine and chlorine form calcium bromide (CaBr₂) and calcium chloride (CaCl₂)), respectively. An Optional Adsorptive Media Heater 541 may be used to maintain the calcium carbonate bed at elevated temperature (optimally 500-600° C.) to enhance reaction kinetics and prevent condensation of certain species. The gas exiting the adsorptive media, designated as Post-Adsorptive Exhaust 542, contains significantly reduced levels of hazardous components and is substantially safer for final polishing or release.

The Post-Adsorptive Exhaust 542, which still contains trace amounts of residual atomic species, metal atoms, metal oxides, and any remaining organic or halogenated fragments that were not fully captured in the upstream calcium carbonate bed then flows into a final polishing media bed 543, such as activated carbon or other high-surface-area materials (e.g., impregnated carbon, silica gel, or polymeric adsorbents) typically consisting of high-surface-area activated carbon. The Post-Adsorptive Stage Reactive or Carrier Gas Injection Line 518 introduces additional reactive or carrier gas that mixes with the Post-Adsorptive Exhaust 542 prior to or within the activated carbon bed. Possible gases include nitrogen for dilution, oxygen or clean dry air for further oxidation of residual metals, or small amounts of other reactive gases to promote specific polishing reactions. This injection can enhance capture efficiency on the activated carbon, help regenerate portions of the media, or adjust the final gas composition. The primary purpose of the activated carbon bed is to provide final polishing by physically adsorbing and chemically binding residual contaminants that pass through the adsorptive media. For example, residual metal atoms such as tungsten, copper, titanium, or silicon, along with their oxides, are strongly adsorbed onto the carbon surface; any remaining organic fragments or volatile halogenated compounds are trapped within the porous structure of the activated carbon. An Optional Activated Media Heater 544 may be employed to maintain the activated carbon bed at an elevated temperature (optimally 200-300° C.) to improve adsorption kinetics, prevent condensation of certain species, and extend the useful life of the media. After passing through the activated carbon, the gas exits as the final Remediated Exhaust 545, which consists primarily of nitrogen, oxygen, and greatly reduced levels of hazardous components, rendering it suitable for safe release into the facility exhaust system.

Between the Stainless-Steel Reactor Housing 522 and the Microwave-Transparent Reactor Housing 525 is an Annular Space 531. This annular space begins at the upper portion of the reactor, fully surrounding the plasma section. As the reactor core expands radially to accommodate the High-Temperature Porous Material 530 and subsequent media beds, the annular space becomes correspondingly narrower while still occupying the region between the outer stainless-steel housing and the inner transparent reactor housing. After passing the dissociation media beds, the annular space continues downward and ultimately directs the annular gas flow into the core region through a series of openings or a dedicated transition zone. At this point, the diameter of the core flow path decreases in a controlled neck-down constriction within the Low-Pressure Eductor Mixing Zone 546. This geometric reduction, combined with the high-velocity annular gas, creates a Venturi-effect low-pressure region. The remediated process gas flows centrally through the reactor, while the high-speed annular gas is injected into the constricted neck, mixing with the process gas and actively motivating (drawing) both the process gas and the annular gas forward and out of the system. This integrated annular architecture provides simultaneous cooling, gas motivation, and dilution of the process stream.

The annular fluid is introduced into this annular space via the Annular Gas Injection Line 516. The motive fluid may comprise inert gases such as nitrogen (N₂) or argon (Ar), compressed dry air, reactive gases such as oxygen (O₂), hydrogen (H₂), water vapor, ammonia (NH₃), or any combination thereof. In a preferred embodiment, Clean Dry Air (CDA) is used as the motive fluid. The Annular Space 531 may be partially or substantially filled with a High-Temperature Gas-Permeable Material 530. In some embodiments, the High-Temperature Gas-Permeable Material 530 substantially insulates and fills the entire annular space. In other embodiments, the porous ceramic media only partially fills the annular space and may be arranged as vertical strips, discrete segments, dots, rings, or other partial-coverage configurations.

The partial-filling configurations are particularly advantageous because they balance effective heat transfer with the need to maintain sufficient open cross-sectional area for high-velocity gas flow. This ensures that the motive fluid exits the annular region at a velocity high enough to properly power the downstream eductor, thereby generating the desired low-pressure region that pulls the process gas through the dissociation media and adsorptive beds. Even when the annular space is substantially filled with porous media, a reasonable radial thickness of the porous ceramic (typically between 5 mm and 25 mm, depending on overall reactor diameter and desired flow rate) can still permit adequate gas throughput to support effective eductor operation.

The Annular Region 531 performs multiple simultaneous functions. First, the motive fluid provides convective cooling of the hot reaction chamber walls and associated components, helping to maintain the outer Stainless-Steel Reactor Housing 522 at safe operating temperatures. Second, the motive fluid absorbs heat from the reactor, acting as a heat-exchange medium. Third, after passing through the annular region, the motive fluid is deliberately accelerated through a neck-down constriction in the Low-Pressure Eductor Mixing Zone 546. This constriction, in cooperation with the annular flow, creates a Venturi-effect low-pressure zone that actively draws the process gas and dissociated species through the Gas Permeable Ceramic Media 523, any downstream stages, and the adsorptive beds.

The Annular Region 531 may optionally contain insulators or heat-exchange structures to enhance thermal transfer and/or gas mixing. Examples of heat-exchange structures include High-Temperature Gas-Permeable Material 530 open-cell foams, sintered particles, or reticulated ceramics, beds of ceramic beads, vertical strips of porous material, or a plurality of axially extending fins. Examples of insulators include closed-cell foams. The porous ceramic material may be fully gas-permeable interconnected open pores or partially non-permeable, depending on the desired balance between heat transfer and pressure drop.

After exiting the annular region and passing through the eductor constriction, the motive fluid mixes with the remediated process gas stream. This integrated eductor architecture annular motive fluid flow+neck-down constriction generates suction that assists gas transport through the entire reactor system. As a result, the need for additional mechanical vacuum pumps or water-based scrubbing systems is significantly reduced or entirely eliminated in many applications.

The combination of the coaxial microwave delivery system, the multi-functional annular motive fluid region (providing cooling via heat exchange, thermal insulation, and gas motivation), the high-temperature porous dissociation media, and the downstream adsorbent and activated media beds results in a highly efficient, compact, dry, true point-of-use remediation system. This embodiment provides improved dissociation performance, reduced ancillary infrastructure requirements, lower cost of ownership, and greater operational flexibility compared to conventional single-stage plasma or burn-wet abatement systems.

It should be understood that any of the embodiments described herein may utilize either the magnetron and coaxial launcher architecture or a solid-state (e.g., GaN) microwave source architecture, or any combination thereof.

In the present continuation-in-part application, the term “dissociation” is used in a broader sense than in the parent application. As used herein, “dissociation” means that at least one chemical bond in a molecule has been broken. For example, a gas stream may be described as 90% dissociated when at least one bond has been broken in 90% of the original molecules. “Complete dissociation” or “atomization” refers specifically to the case in which all chemical bonds of a given molecule have been broken for substantially 100% of the original molecules, resulting in individual atoms or the smallest possible stable fragments. The reactor embodiments and claims of the present continuation-in-part application are intended to encompass any and all degrees of dissociation and complete dissociation, as well as any distribution of molecular fragments that may result from the combined plasma and pyrolytic processes.

Additional embodiments of the reactor include variations in the design of the core plasma region. These include multi-pass flow geometries, advanced conductive emitter coil designs, hybrid plasma-pyrolytic configurations, and various arrangements of porous dissociation media within the reaction chamber.

Referring now to FIG. 6, a multi-pass embodiment of the plasma remediation reactor is shown. The reactor is substantially as described with respect to FIG. 5, except as noted below. The low-pressure eductor mixing zone is not illustrated in this Figure.

In this multi-pass embodiment, the process gas is channeled through a Multi-Pass High-Temperature Microwave Transparent Reactor Housing 600 that forces the gas to traverse the microwave field generated by the conductive emitter a plurality of times before exiting the reaction chamber. As shown in FIG. 6, this architecture creates multiple traversals, a first pass 601 and a second pass 602 through the dissociation zone. The extended residence time and repeated exposure to the high-intensity microwave field or plasma significantly enhances dissociation efficiency, particularly for difficult-to-dissociate molecules. This design allows optimization of gas velocity, turbulence, and interaction with the Microwave Emitter 521 while maintaining compact overall reactor dimensions.

The reactor may further incorporate the Gas Permeable Ceramic Media 523, packed or positioned within the Multi-pass High-Temperature Microwave Housing 600 chamber to increase surface area, promote intimate gas-media interaction, and assist in energy transfer. This dissociation media is distinct from the heat-exchange structures in the annular region and from the downstream adsorbent beds. Suitable forms include loose aggregate such as ceramic beads, granules, or pellets; a single-piece open-pore ceramic monolith or foam; or complex structures fabricated by additive manufacturing (3D printing) techniques. Additive-manufactured media can provide precisely engineered pore geometries, optimized flow channels, and tailored microwave absorption properties.

Overall, the multi-pass architecture of FIG. 6 substantially increases the residence time of the gas molecules within the high-intensity microwave field compared to single-pass designs. By repeatedly exposing the process gas to the plasma and/or pyrolytic dissociation zone, this embodiment achieves significantly higher dissociation efficiency, particularly for stable or difficult-to-treat molecules, while still maintaining a compact reactor footprint.

Referring now to FIG. 7, an embodiment of the plasma remediation reactor utilizing a solid-state microwave source and incorporating a double-helix emitter configuration is shown. The reactor is substantially as described with respect to FIG. 5, except as noted below. The low-pressure eductor mixing zone is not illustrated in this Figure.

In this embodiment, Microwave power is generated by two different GaN Solid State Microwave Sources 700 and delivered through EIA Coaxial Connector 705 to the first emitter and EIA Coaxial Connector 707 to the second Emitter. Microwave energy is introduced by a double-helix emitter configuration consisting of two interleaved helical coils: Microwave Helix 1 Emitter 701 and Microwave Helix 2 Emitter 702. These interleaved helices can be powered independently, allowing for increased microwave power density, greater control over the electromagnetic field, and improved uniformity within the reaction chamber.

The emitters are enclosed within a Stainless-Steel Reactor Housing 522. Between the Stainless-Steel Reactor Housing 522 and the Microwave Transparent Reactor Housing 522 is Annular Space 531 through which Annular Gas Fluid 526 flows. This annular flow provides convective cooling of the reactor components and contributes to gas motivation through the system.

This double-helix independently powered emitter embodiment offers enhanced microwave power density and field uniformity. When combined with the GaN solid-state microwave source(s), the multi-functional annular gas motivation and cooling system, and high-temperature porous media, it delivers enhanced dissociation efficiency for a wide range of hazardous gases in a compact, dry, true point-of-use design.

Referring now to FIG. 8, a hybrid plasma/pyrolytic embodiment of the plasma remediation reactor is shown. The low-pressure eductor mixing zone described in FIG. 5 is not shown in this Figure.

A GaN Solid State Microwave Source 700 delivers microwave power through an EIA Coaxial Connector 705 into the reactor. Process exhaust gas is drawn from a Semiconductor Process Backing Vacuum Pump 508. Un-Remediated Process Exhaust 509 enters and may be mixed with reactive or carrier gases supplied by the Pre-Remediation Mixing Reactive or Carrier Gas Injection Line 515, controlled by a Gas Injection Module Assembly 510. The resulting Mixed Fluid 514 enters the reactor. An Annular Fluid Injection Line 516 is also controlled by the Gas Injection Module Assembly 510.

The reactor includes a Microwave Emitter 521 enclosed within a Stainless-Steel Reactor Housing 522 surrounding a Microwave Transparent Reactor Housing 525. Between the Stainless-Steel Reactor Housing 522 and the Microwave Transparent Reactor Housing 525 is an Annular Space 531 through which Annular Gas Fluid 526 flows. This annular flow provides cooling by convection.

In this hybrid plasma/pyrolytic embodiment, dissociation occurs through a combination of plasma generation and pyrolytic heating. The Mixed Fluid 514 first passes through the plasma reactor stage powered by GaN Solid State Microwave Source 700, fed by EIA Coaxial Connector 705 to Microwave Emitter 521 for initial plasma dissociation. The fluid then flows through a separate pyrolytic reactor stage comprising an independently controlled emitter coil 804, powered by a second GaN Solid State Microwave Source 700 through an EIA Coaxial Connector 807. The coil 804 is insulated by Carbon Felt 805 disposed between the Pyrolytic Stage Emitter 804 and the Microwave Transparent Reactor Housing 525.

Within the pyrolytic stage, two possible media configurations are shown. One configuration uses a High-Temperature Gas Permeable Pyrolytic Media 801 together with independent Microwave-Absorptive Rods 802 spaced within the non-absorptive media. The High-Temperature Gas Permeable Pyrolytic Media 801 and the Microwave-Absorptive Rods 802 are both supported by screen 806. These rods absorb microwave energy, become intensely hot, and transfer thermal energy by conduction and radiation to the surrounding media and process gas, thereby promoting strong pyrolytic dissociation in addition to any plasma-induced dissociation. In alternative embodiments, the media itself 801 is fabricated from a microwave-absorptive material. In this case, separate susceptor rods are not required, as the media directly absorbs the microwave energy and provides the pyrolytic heating effect. The gas exiting this hybrid stage is shown as Dissociated Gas Post High-Temperature Gas Permeable Pyrolytic Media 803.

In a proposed mechanism of dissociation, the hybrid plasma/pyrolytic embodiment of FIG. 8, the reactor separates the dissociation process into two synergistic stages. In the upstream plasma stage, high-energy electrons efficiently initiate dissociation of the parent molecules (e.g., SF₆) by electron-impact dissociation, rapidly stripping multiple fluorine atoms and producing a mixture of lower fluorides (SFₓ, x=1-5) and atomic species. However, complete atomization of these intermediate fragments can be kinetically limited in a non-thermal plasma due to lower cross-sections for further electron-impact dissociation and competing recombination reactions.

The downstream pyrolytic stage, heated by microwave-absorptive susceptors or absorptive media to temperatures in the pyrolytic regime (typically 900-1200° C.), provides sustained thermal energy that effectively drives the remaining S—F bonds to completion via vibrational excitation and thermal decomposition pathways. This staged approach-plasma for rapid initial bond breaking followed by pyrolysis for thorough atomization of refractory fragments-achieves higher overall dissociation efficiency and lower residual molecular fragments than either process alone.

This hybrid configuration synergistically separates non-thermal plasma dissociation from intense conductive pyrolytic heating provided by the SiC susceptor material or absorptive media. This arrangement removes the high-temperature source from the plasma stage, helping to protect the plasma stage components from excessive pyrolytic temperatures. Integrated with the GaN Solid State Microwave Source 700 and the multi-functional annular gas motivation/cooling system, this reactor configuration enables highly efficient dissociation of difficult-to-treat gases while maintaining manageable external component temperatures and a compact, dry, true point-of-use design.

Referring now to preferred embodiment FIGS. 9A and 9B, a low-maintenance embodiment of the high-efficiency plasma remediation reactor system is shown.

In FIG. 9A the reactor is configured substantially as described with respect to FIG. 8 (hybrid plasma-pyrolytic stages with annular motive fluid architecture), except that the low-pressure eductor mixing zone shown in FIG. 5 is not illustrated. FIG. 9B shows the CaCO₃ adsorbent bed 902 and activated carbon media bed 903 are positioned in the foreline, immediately upstream of the backing vacuum pump assembly 908.

Process exhaust gas exits Turbo Molecular Pump (TMP) 901 from the semiconductor process chamber (Not shown) and flows through Exhaust Line 911 into the remediation reactor 905. After passing through the hybrid plasma and pyrolytic dissociation stages, the dissociated gas 803 continues downstream, where a Backing Vacuum Pump Assembly 908 comprising a Roots Pump 906 and a Rotary Vane Pump 907 pulls the dissociated molecules through the Adsorptive Media 902 (CaCO₃) and the Activated Media 903 (activated carbon). The final Remediated Exhaust 904 exits to a facility scrubber or atmosphere.

This configuration allows the reactor to be positioned directly at the TMP exhaust line near the process chamber while placing the polishing media (CaCO₃ and activated carbon beds) in the backing pump foreline for convenient access and maintenance.

The foreline at Backing Pump 908 comprises Access Doors 910 and 912 configured to provide easy replacement of the CaCO₃ bed 902 and activated carbon bed 903, or any other chemically reactive or physically adsorptive media suitable for capturing atomic species and molecular fragments. These access doors may be configured as parallel or redundant gas paths (not shown) to enable maintenance without interrupting system operation.

The foreline placement of the removable adsorbent and activated carbon media beds enables rapid replacement during scheduled maintenance or while the connected process tool remains in production, thereby minimizing tool downtime. This configuration allows servicing of the media beds without breaking vacuum on the main reactor chamber or requiring extensive purge cycles. In addition, positioning the reactor itself at the point-of-use, immediately downstream of the process chamber, reduces or eliminates contaminated foreline piping, thereby reducing the risk of byproduct deposition and particle generation. When combined with the dry, low-consumable design of the reactor, the present system provides significantly lower cost of ownership, a smaller facility footprint, and improved overall equipment effectiveness compared to conventional centralized plasma, burn-wet, or thermal abatement systems.

### EXAMPLE 1. Plasma Dissociation Testing in Quartz Tube Reactor

On Mar. 5, 2026, testing was conducted on a double-pass quartz tube reactor embodiment utilizing a tightly wrapped copper coil emitter. The configuration included a 1-inch diameter outer quartz tube with a 3/16-inch copper coil emitter wrapped tightly around the tube with 13 turns at approximately 0.5-inch spacing. Inside the outer quartz tube was a smaller diameter 0.4″ ID inner quartz tube disposed such that the gas was injected into the inner tube and was then redirected to pass through the space between the inner and outer tubes, in the opposite direction. In this way, the gas passed through the entirety of the microwave field twice. The outer quartz tube had a length of 12 inches while the inner quartz tube had a length of 11.5 inches. The active coiled length was 10.5 inches.

In Run 1, the reactor was operated with a single 2.45 GHz magnetron at 1.2 kW power. The gas flow consisted of 3 lpm CO₂ mixed with 7 lpm air at 1 atm. A Tekcoplus AZ7755 CO₂ detector sampled the gas immediately downstream of the plasma zone and prior to the adsorbent bed. With the plasma off, the detector read 1,100 ppm CO₂. When the plasma was activated, the CO₂ concentration dropped to 600 ppm, demonstrating substantial dissociation.

In Run 2, 10 lpm N₂ was mixed with 3 lpm CO₂ at 0.5 atm. With the plasma off, the CO₂ concentration was 1,200 ppm and rising. At 70% power, the plasma was struck and the CO₂ concentration stabilized at 950 ppm. Simultaneously, a TopTes Guard-101 O₂ meter showed the oxygen concentration rising from 15% to 17% and continuing to increase, confirming dissociation of CO₂ into carbon-containing species and oxygen.

### EXAMPLE 2. Pyrolytic Performance of Microwave-Heated Alumina Bead Bed

In a further experiment conducted to evaluate the pyrolytic performance of the hybrid system, a magnetron housing was mounted directly to the end of a 57 mm outer diameter, 50.8 mm inner diameter alumina tube having a length of 150 mm. The magnetron probe tip was axially centered and isolated from the reactor gases by a 2 mm thick quartz window sealed to the interior of the alumina tube, positioned 2 mm below the probe tip. The alumina tube was filled with 2-3 mm diameter alumina beads to a height of 1 cm below the quartz window.

Microwave power at 2.45 GHz and 1.2 KW was applied to an alumina bead bed for a total of 15 minutes. The external surface temperature of the alumina tube was measured at a position 5 cm from the bottom using a Type-K thermocouple at 5-minute intervals. The recorded external wall temperatures were approximately 150° C., 350° C., and 500° C., with the temperature continuing to climb rapidly at the end of the 15-minute test.

Under flow conditions consisting of 20 L/min of atmosphere at 22° C., the thermal gradient between the outer tube wall and the interior of the alumina bead bed, and the rapid temperature rise observed, allows an estimation of the temperature of the bead bed. The bead bed is expected to have reached a temperature of 950° C. to 1,050° C. when the external wall temperature was measured at 500° C. This internal temperature places the bead bed well within the pyrolytic regime required for efficient dissociation of many hazardous gases.

It is to be understood that the various features and embodiments described herein and illustrated in the figures are not intended to be mutually exclusive. The reactor of the present invention may incorporate any combination of the disclosed features. One skilled in the art will recognize that numerous combinations and modifications are possible without departing from the scope of the invention.

1. A gas-phase reactor for dissociating gas-phase molecules, comprising:
a housing defining an interior reaction chamber having a gas inlet and a gas outlet;
a microwave source configured to generate microwave power;
a transmission system coupled to the microwave source for delivering the microwave power to the reaction chamber;
and a conductive emitter coupled to the transmission system and positioned to re-radiate microwave energy into the reaction chamber, whereby the emitter enables the generation of plasma and/or pyrolytic dissociation of the gas molecules passing through the reaction chamber.

2. The gas-phase reactor of claim 1, wherein the microwave source comprises a magnetron.

3. The gas-phase reactor of claim 2, further comprising a coaxial magnetron launcher coupled to the magnetron, the launcher configured to deliver the microwave power via a coaxial cable to the conductive emitter.

4. The gas-phase reactor of claim 1, wherein the microwave source comprises a solid-state microwave generator.

5. The gas-phase reactor of claim 4, wherein the solid-state microwave generator comprises a Gallium Nitride (GaN) amplifier.

6. The gas-phase reactor of claim 1, wherein the conductive emitter comprises a coil, a straight rod with optional geometric perturbations along the rod, a double-helix configuration with independently powered interleaved helices, or any combination thereof.

7. The gas-phase reactor of claim 1, further comprising a hybrid plasma-pyrolytic section, wherein a plasma zone created by the conductive emitter effects initial dissociation of the gas molecules, and a separate pyrolytic stage containing one or more microwave-absorptive susceptors or absorptive media provides thermal dissociation of molecular fragments.

8. The gas-phase reactor of claim 7, wherein the plasma section and the pyrolytic section are powered independently.

9. The gas-phase reactor of claim 1, wherein the reaction chamber includes a containment configured to channel the process gas in a multi-pass configuration such that the gas passes through the microwave field a plurality of times.

10. The gas-phase reactor of claim 1, further comprising a CaCO₃ adsorbent bed downstream of the reaction chamber for capturing dissociated molecular fragments and atomic species.

11. The gas-phase reactor of claim 10, further comprising an activated carbon media bed downstream of the CaCO₃ adsorbent bed for final polishing.

12. A gas-phase reactor for dissociating gas-phase molecules, comprising: a reaction chamber containing dissociation media configured to effect plasma dissociation, pyrolytic dissociation, or a combination thereof; an annular region surrounding at least a portion of the reaction chamber; a motive-fluid inlet in fluid communication with the annular region; and a neck-down constriction located downstream of the annular region, wherein the annular region and the neck-down constriction are cooperatively configured to form a low-pressure eductor that draws process gas through the dissociation media and any downstream remediation stages while mixing and diluting the exhaust stream.

13. The gas-phase reactor of claim 12, wherein a heat-exchange structure is disposed in the annular region, the heat-exchange structure selected from the group consisting of a high-surface-area gas-permeable porous ceramic material occupying substantially the entire annular space, a high-surface-area gas-permeable porous ceramic material spaced from the outer wall so as to leave a gap for carrier gas flow, ceramic beads, vertical strips of porous material, and a plurality of vertical fins extending axially within the annular region.

14. A gas remediation system comprising: a reaction chamber configured for plasma and/or pyrolytic dissociation of process gases; a foreline downstream of the reaction chamber; an eductor positioned in the foreline upstream of a backing vacuum pump, the eductor comprising an annular motive-fluid inlet in fluid communication with a motive fluid source and a neck-down constriction located downstream of the annular inlet; and at least one adsorbent bed positioned in the foreline downstream of the eductor and upstream of the backing vacuum pump.

15. The gas remediation system of claim 14, wherein the eductor creates a high-velocity gas stream in the foreline that motivates gas flow through the reaction chamber and reduces recombination of dissociated species.

16. The gas remediation system of claim 14, further comprising means for injecting a reactive gas into the foreline downstream of the reaction chamber to oxidize atomic species prior to or within the adsorbent bed.

17. The gas remediation system of any one of claim 14, wherein the reaction chamber is positioned at or near the exhaust of a semiconductor process chamber, such that the system provides point-of-use dissociation while locating the adsorbent bed in the foreline for convenient access and maintenance.

18. The gas remediation system of any one of claim 14, further comprising a foreline media assembly including a first adsorbent bed containing calcium carbonate (CaCO₃) followed by a second polishing bed containing activated carbon, and one or more access doors or removable cartridges configured to allow replacement or maintenance of the media while the process tool and reactor continue to operate.

19. A method of remediating hazardous process gas comprising: (a) flowing the process gas through a reaction chamber configured for plasma and/or pyrolytic dissociation; (b) introducing a motive fluid into an annular region surrounding at least a portion of the reaction chamber; (c) accelerating the motive fluid through a neck-down constriction in the foreline downstream of the reaction chamber to create a low-pressure zone that draws the process gas through the dissociation zone; and (d) passing the dissociated gas through at least one adsorbent bed located in the foreline downstream of the constriction and upstream of a backing vacuum pump.

20. The method of claim 19, further comprising injecting a reactive gas selected from oxygen or clean dry air into the gas stream after the dissociation zone and prior to or within the adsorbent bed so as to oxidize atomic species and improve their capture efficiency.

21. The method of claim 19, wherein the reaction chamber is operated at or near the point of use immediately downstream of a semiconductor process chamber, and the adsorbent bed is located in the foreline upstream of the backing vacuum pump, thereby enabling convenient media maintenance without interrupting tool operation.
